(19) United States
(12) Patent Application Publication
(10) Pub. No.: US 2006/0238553 A1
(43) Pub. Date: Oct. 26, 2006

(54) Droplet ejectiing method and droplet ejection apparatus, thin film forming method and device, and electronic device

(75) Inventors: Hidekazu Moriyama, Fujimi-machi (JP); Kei Hiruma, Chino-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/407,258

(22) Filed: Apr. 20, 2006

(30) Foreign Application Priority Data
Apr. 22, 2005 (JP) JP2005-124595

(51) Int. Cl. B41J 29/38

(52) U.S. Cl. 347/10

(57) ABSTRACT

A drive signal is applied to a pressure-generating element to create pressure that corresponds to the drive signal inside a cavity, and liquid stored in the cavity is ejected as droplets. To enable stable droplet ejection even when a highly viscoelastic material is used, the drive signal contains a first waveform part c for adding a second voltage Vch to a reference potential Vc that is larger than a specific potential by a first voltage Vbc to create negative pressure in the cavity, a second waveform part h for holding the negative pressure in the cavity for a specific amount of time with a hold potential Vh that is larger than the reference potential Vc by the second voltage Vch, and a third waveform part d for reducing the voltage from the hold potential Vh to the specific potential Vb by a third voltage Vbh to increase the pressure in the cavity; and the first voltage Vbc is 10% or less, preferably 4% or less, than the third voltage Vbh.

### FIELD OF THE INVENTION

The present invention relates to a droplet ejection method and droplet ejecting apparatus, a thin film forming method and device, and an electronic device.

### BACKGROUND TECHNOLOGY

Production is currently expanding for liquid crystal display devices, organic EL (electroluminescence) displays, color filter substrates, micro-lens arrays, and other devices. Droplet ejecting apparatuses that eject tiny viscous liquid as droplets are used in such production.

Using such manufacturing methods can greatly improve production efficiency over manufacturing in which photographic methods are used. Also, the aforementioned color filter substrates are manufactured by ejecting specific amounts of an organic material onto specific locations to form a colored layer, and the organic EL displays are manufactured by using an ejection apparatus to form an organic material that forms a light-emitting layer on a substrate.

The droplet ejecting apparatus includes multiple nozzles for ejecting viscous liquid from a head, but if the viscous liquid is not ejected in a stable manner from each of the nozzles, the result is a problem in which so-called airborne curving occurs and droplets cannot be deposited at specific locations. Also, nonuniform ejected amounts (ejected weight) may, for example, result in the production of a micro-lens array in which micro-lenses that are nonuniform in size or shape are formed, or in the production of a color filter or an organic EL display that has color nonuniformities. Therefore, with ejection apparatuses used to manufacture the various devices described above, the amounts of viscous liquid ejected from the nozzles must be uniform.

In order to resolve the problem of nonuniformities in the ejected amounts of viscous liquid, Prior Art 1 discloses an invention wherein a drive signal is generated having a plurality of drive pulses with different waveforms in one ejection cycle, and one drive pulse selected from these drive pulses is applied to the piezoelectric elements or other such pressure-generating elements provided to the nozzles, whereby nonuniformities in the ejected amounts between nozzles are corrected. In this invention, nonuniformities in the ejected amounts between nozzles are corrected by measuring the ejected amounts of viscous liquid ejected from the nozzles when drive pulses having the same waveform are applied to all of the pressure-generating elements in advance, selecting a drive pulse whereby the nonuniformities in the ejected amounts can be corrected, and applying this drive pulse to the pressure-generating elements. [Prior Art 1] Japanese Patent Application Laid-Open No. 2003-320291

### SUMARY OF THE INVENTION

[Problems to be Solved by the Invention]

However, the conventional techniques described above have the following problems.

When droplets are ejected using a macromolecular polymer or another highly viscoelastic material as a solute, stable ejection becomes difficult to accomplish because the tail ends of the droplets cannot be easily separated.

This results in problems wherein airborne curving occurs and the precision with which droplets are deposited is reduced.

It is also difficult to form a film of a specific size (line width, for example), because nonuniformities also occur in the size of the deposits (deposition diameter).

The present invention was designed in view of such circumstances as described above, and an object thereof is to provide a droplet ejection method, a droplet ejecting apparatus, and a thin film forming method whereby stable droplet ejection is possible even when highly viscoelastic materials are used, and also to provide a device and an electronic device manufactured by these methods.

[Means for Solving the Problems]

The present invention employs the following configuration in order to achieve the aforementioned objects.

The present invention provides a droplet ejection method for applying a drive signal to a pressure-generating element, generating pressure that corresponds to the drive signal inside a cavity, and ejecting as droplets the liquid stored inside the cavity; the method comprising providing the drive signal with a first waveform part for adding a second voltage to a reference potential that is greater than a specific potential by a first voltage to create negative pressure in the cavity, a second waveform part for holding the negative pressure in the cavity for a specific amount of time with a hold potential that is greater than the reference potential by the second voltage, and a third waveform part for reducing the voltage from the hold potential to the specific potential by a third voltage to increase the pressure in the cavity; and keeping the first voltage at 10% or less, preferably 4% or less, of the third voltage.

Therefore, in the droplet ejection method of the present invention, the second voltage, which is applied to the reference potential by the first waveform part when negative pressure is generated to draw liquid into the cavity, is 90% or more of the third voltage applied by the third waveform part to increase the pressure in the cavity. Thus, drawing liquid into the cavity by using a large applied voltage causes the shear rate (shearing rate) to increase. As a result, the viscosity of the liquid can be reduced. Therefore, it is possible to reduce adverse effects of viscosity even when a highly viscoelastic material is used, and stable droplet ejection can be achieved. As a result, it is possible to eject droplets in a stable manner at high frequency ranges.

The time period for the second waveform part is preferably ½ or less of the time period for the first waveform part, and ½ or less of the time period for the third waveform part, and is more preferably ⅓ or less of the time period for the first waveform part, and ⅓ or less of the time period for the third waveform part.

Therefore, in the droplet ejection method of the present invention, it is possible to avoid instances in which the liquid becomes more viscous and is more difficult to eject as droplets as a result of the fact that the shear rate of the liquid increases while the liquid is held in the cavity.

The present invention can also be suitably used with a liquid containing a macromolecular polymer having an average molecular weight of 70,000 or more as a solute.

The present invention provides a thin film forming method for applying a drive signal to a pressure-generating element, generating a pressure that corresponds to the drive signal inside a cavity, and ejecting as droplets the liquid stored in the cavity onto a substrate to form a thin film, wherein the droplets are ejected onto the substrate by the above-described droplet ejection method.

Therefore, in the present invention, it is possible to reduce the adverse effects of viscoelasticity even when a highly viscoelastic material is used, to suppress nonuniformities in airborne curving and deposition time, and to form a high-quality thin film on the substrate.

The thin film forming method of the present invention preferably comprises making the substrate lyophilic with respect to the liquid.

In the present invention, the liquid deposited on the substrate can thereby be made to expand while it wets the substrate, and specific areas can be coated with the liquid.

The device of the present invention has a substrate on which a thin film is formed by the thin film forming method previously described.

Also, the electronic device of the present invention comprises the above-described device.

Therefore, in the present invention, it is possible to provide a high-quality device and electronic device wherein a thin film is formed on a specific area of a substrate.

The present invention provides a droplet ejecting apparatus having a head provided with a cavity for storing liquid and with a pressure-generating element for creating pressure in the cavity according to an applied drive signal, the apparatus further comprising a signal control for applying, as a drive signal, a signal having a first waveform part for adding a second voltage to a reference potential that is greater than a specific potential by a first voltage to create negative pressure in the cavity, a second waveform part for holding the negative pressure in the cavity for a specific amount of time with a hold potential that is greater than the reference potential by the second voltage, and a third waveform part for reducing the voltage from the hold potential to the specific potential by a third voltage to increase the pressure in the cavity; and keeping the first voltage in the signal at 10% or less, preferably 4% or less, of the third voltage.

Therefore, in the droplet ejecting apparatus of the present invention, the second voltage, which is applied to the reference potential by the first waveform part when negative pressure is generated to draw liquid into the cavity, is 90% or more of the third voltage applied by the third waveform part to increase the pressure in the cavity. Thus, drawing liquid into the cavity by using a large applied voltage causes the shear rate (shearing rate) to increase. As a result, the viscosity of the liquid can be reduced. Therefore, it is possible to reduce adverse effects of viscosity even when a highly viscoelastic material is used, and stable droplet ejection can be achieved. As a result, it is possible to eject droplets in a stable manner at high frequency ranges.

The time period for the second waveform part is preferably ½ or less of the time period for the first waveform part, and ½ or less of the time period for the third waveform part, and is more preferably ⅓ or less of the time period for the first waveform part, and ⅓ or less of the time period for the third waveform part.

Therefore, in the droplet ejection method of the present invention, it is possible to avoid instances in which the liquid becomes more viscous and is more difficult to eject as droplets as a result of the fact that the shear rate of the liquid increases while the liquid is held in the cavity.

The present invention can also be suitably used with a liquid containing a macromolecular polymer having an average molecular weight of 70,000 or more as a solute.

### BRIEF DESCRIPTION OF THE DRAWINGS

Referring now to the attached drawings which form a part of this original disclosure.

FIG. 1 is a perspective view showing the schematic configuration of a droplet ejecting apparatus according to an embodiment of the present invention;

FIG. 2 is an exploded perspective view of an ejection head;

FIG. 3 is a perspective view showing part of the main portion of an ejection head;

FIG. 4 is a diagram showing the basic waveform of a drive signal for operating the piezoelectric element;

FIG. 5 is a diagram showing the operation of the piezoelectric element during droplet ejection;

FIG. 6 is a cross-sectional view showing an example of the configuration of the organic EL device; and

FIG. 7 is a cross-sectional view showing an example of the configuration of the liquid crystal display device.

### DESCRIPTION OF THE PREFERRED EMBODIMENTS

Embodiments of the present invention will be described hereinafter with reference to the drawings. As is clear from the disclosure of the present invention to one skilled in the art, the description relating to working examples of the present invention is given only for the purpose of describing the present invention, and shall not be construed as limiting the present invention as defined within the scope of the claims described hereinafter, or within an equivalent range.

Embodiments of the droplet ejection method, the droplet ejecting apparatus, the thin film forming method, the device, and the electronic device of the present invention are described hereinbelow with reference to the diagrams 1 through 7.

[Droplet Ejecting Apparatus]

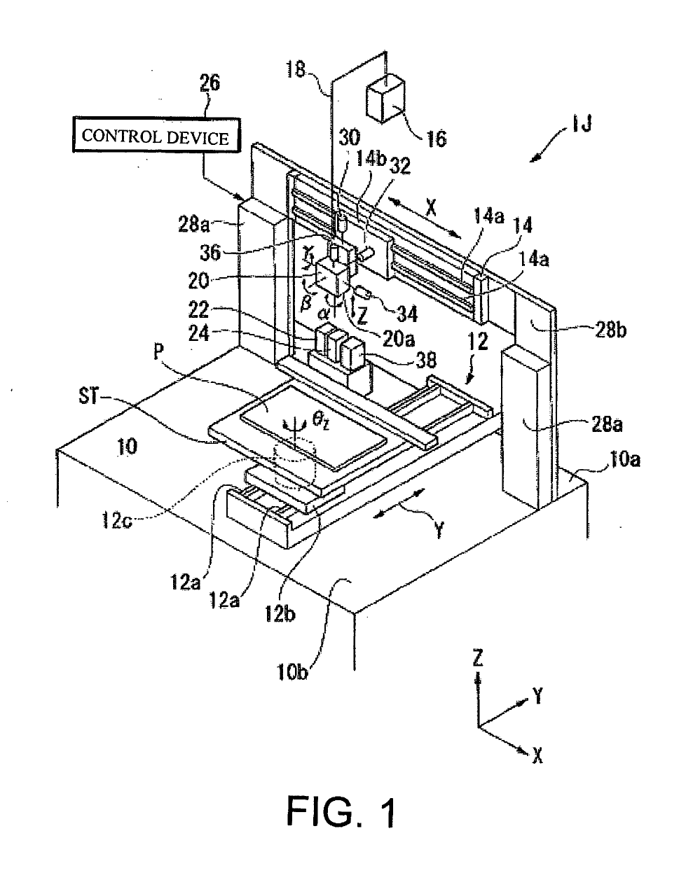

FIG. 1 is a perspective view showing the schematic configuration of a droplet ejecting apparatus according to one embodiment of the present invention. In the following description, an XYZ orthogonal coordinate system is specified in the diagrams as necessary, and the positional relationships of the components are described with reference to this XYZ orthogonal coordinate system. In this XYZ orthogonal coordinate system, the XY plane is set to a plane parallel to the horizontal plane, and the Z axis is set in a vertical direction. Also, in the present embodiment, the direction of movement of the ejection head (head, droplet ejection head) 20 is set in the X direction, and the direction of movement of the stage ST is set in the Y direction.

As shown in FIG. 1, the droplet ejecting apparatus IJ of the present embodiment comprises a base 10, a stage ST for supporting a glass substrate or another substrate P on the base 10, and an ejection head 20 that is supported above the stage ST (in the +Z direction) and that is capable of ejecting specific droplets onto the substrate P. A first moving device 12 for movably supporting the stage ST in the Y direction is provided between the base 10 and the stage ST. Also, a second moving device 14 for movably supporting the ejection head 20 in the X direction is provided above the stage ST.

A tank 16 (a reservoir tank) for storing a droplet solvent (liquid) to be ejected from the ejection head 20 is connected to the ejection head 20 via a flow channel 18. Also, a capping unit 22 and a cleaning unit 24 are disposed on the base 10. A control device (signal control device) 26 controls the operation of the entire droplet ejecting apparatus IJ by controlling all of the components of the droplet ejecting apparatus IJ (for example, the first moving device 12, the second moving device 14, and the like).

The first moving device 12 is disposed on the base 10, and is positioned along the direction of the Y axis. The first moving device 12 is configured from a linear motor, for example, and includes guide rails 12a, 12a and a slider 12b capable of moving along these guide rails 12a. The slider 12b of this linear motor-type of first moving device 12 can be positioned by moving along the guide rails 12a in the Y axis direction.

The slider 12b also includes a motor 12c for rotating around the Z axis (θZ). This motor 12c is a direct drive motor, for example, and the rotor of the motor 12c is fastened to the stage ST. The rotor and the stage ST can thereby be rotated in the direction θZ by energizing the motor 12c, and the stage ST can be indexed (rotation can be incremental). Specifically, the first moving device 12 is capable of moving the stage ST in the Y axis direction and in the θZ direction. The stage ST holds the substrate P and positions the substrate at specific positions. Also, the stage ST has an suction holding device (not shown), and this suction holding device operates to suction and hold the substrate P on the stage ST by means of suction holes (not shown) formed in the stage ST.

The second moving device 14 is assembled and mounted on the base 10 using support pillars 28a, 28a, and is mounted at the back section 10a of the base 10. This second moving device 14 is configured from a linear motor and is supported by a column 28b fastened to the support pillars 28a, 28a. The second moving device 14 includes guide rails 14a supported on the column 28b, and a slider 14b capable of moving in the X axis direction along the guide rails 14a. The slider 14b is capable of being moved and positioned in the X axis direction along the guide rails 14a. The ejection head 20 is mounted on the slider 14b.

The ejection head 20 has motors 30, 32, 34, and 36 as oscillation positioning devices. The ejection head 20 can be moved up and down along the Z direction if the motor 30 is driven, and the ejection head 20 can be disposed at an arbitrary position in the Z direction. The ejection head 20 can be oscillated in the β direction around the Y axis if the motor 32 is driven, and the angle of the ejection head 20 can be adjusted. If the motor 34 is driven, the ejection head 20 can be oscillated along the γ direction around the X axis, and the angle of the ejection head 20 can be adjusted. If the motor 36 is driven, the ejection head 20 can be oscillated along the α direction around the Z axis, and the angle of the ejection head 20 can be adjusted.

Thus, the ejection head 20 shown in FIG. 1 is capable of moving in a straight line in the Z direction, and is supported on the slider 14b so as to be capable of oscillating in the α, β, and γ directions, and of having its angle adjusted. The position and orientation of the ejection head 20 are precisely controlled by a control device 26 so that the droplet ejection surface 20a assumes a specific position or a specific orientation in relation to the substrate P on the stage ST. The droplet ejection surface 20a of the ejection head 20 is provided with a plurality of nozzle openings for ejecting droplets.

Possible examples of materials for the droplets ejected from the ejection head 20 described above include ink that contains colored material; dispersion liquid that contains metal microparticles or another material; a solution that contains PEDOT:PSS or another hole injection material, or a light emitting material or other organic EL material; a liquid crystal material or other highly viscous functional liquid; a functional liquid that contains a micro-lens material; a biopolymer solution that contains proteins or nucleic acids; and other materials.

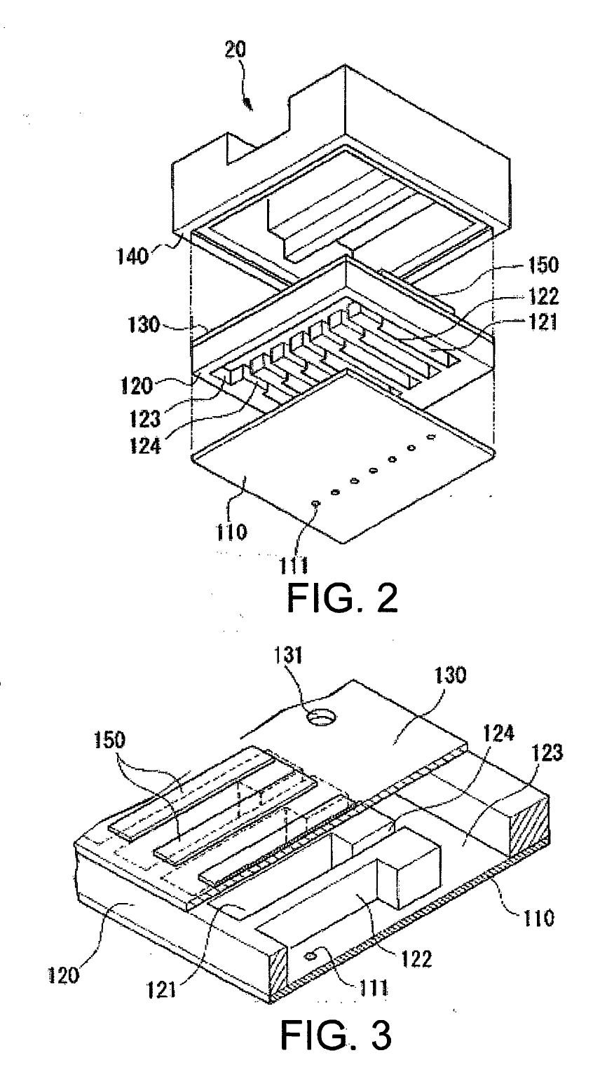

The configuration of the ejection head 20 will now be described. FIG. 2 is an exploded perspective view of the ejection head 20, and FIG. 3 is a perspective view showing part of the main portion of the ejection head 20. The ejection head 20 shown in FIG. 2 has a nozzle plate 110, a pressure chamber substrate 120, a vibrating plate 130, and a casing 140. As shown in FIG. 2, the pressure chamber substrate 120 includes cavities 121, side walls 122, a reservoir 123, and supply ports 124. The cavities 121 are pressure chambers, and are formed by etching a substrate made of silicon or the like. The side walls 122 are configured so as to partition the cavities 121 from each other, and the reservoir 123 is configured as a common flow duct that is capable of supplying liquid when the liquid is to be filled into the cavities 121. The supply ports 124 are configured to be capable of introducing a liquid into the cavities 121.

As shown in FIG. 3, the vibrating plate 130 can be affixed to one side of the pressure chamber substrate 120. A piezoelectric element (pressure generating element) 150 is provided as a pressure-generating element to the vibrating plate 130. The piezoelectric element 150 is a ferroelectric crystal having a perovskite structure, and is configured in a specific shape formed on the vibrating plate 130. The piezoelectric element 150 can bring about volume changes according to a drive signal supplied from the control device 26. The nozzle plate 110 is affixed to the pressure chamber substrate 120 so that the nozzle openings 111 are disposed at positions corresponding to each of the plurality of cavities (pressure chambers) 121 provided to the pressure chamber substrate 120. Furthermore, the pressure chamber substrate 120 to which the nozzle plate 110 is affixed is fitted into the casing 140 to form the ejection head 20, as in FIG. 2.

In order for droplets to be ejected from the ejection head 20, first, the control device 26 supplies a droplet-ejecting drive signal to the ejection head 20. The liquid flows into the cavities 121 of the ejection head 20, and when the drive signal is supplied to the ejection head 20, the piezoelectric element 150 provided to the ejection head 20 causes a change in volume according to the drive signal. This change in volume deforms the vibrating plate 130 and changes the volume of the cavities 121. As a result, droplets are ejected from the nozzle openings 111 of the cavities 121. The liquid that is lost through ejection is newly fed from the tank 16 into the cavities 121 from which droplets have been ejected.

Returning to FIG. 1, the second moving device 14 can selectively position the ejection head 20 over the cleaning unit 24 or the capping unit 22 by moving the ejection head 20 in the X axis direction. In other words, the ejection head 20 can be cleaned if the head is moved, for example, above the cleaning unit 24 even when the device is being manufactured. Also, if the ejection head 20 is moved above the capping unit 22, it is possible to cap the droplet ejection surface 20a of the ejection head 20, to fill the cavities 121 with droplets, and to recover from ejection failures resulting from clogging of the nozzle openings 111 or the like.

In other words, the cleaning unit 24 and the capping unit 22 are disposed toward the back section 10a of the base 10, directly beneath the movement path of the ejection head 20, and away from the stage ST. The substrate P is moved in and out in relation to the stage ST closer to the front section 10b of the base 10, and therefore the cleaning unit 24 and the capping unit 22 do not hinder the operation.

The cleaning unit 24 is capable of cleaning the nozzle openings 111 and other parts of the ejection head 20 either periodically or as needed while the device is being manufactured or during standby. The capping unit 22 caps the droplet ejection surface 20a during standby when the device is not being manufactured, so that the droplet ejection surface 20a of the ejection head 20 does not become dry. The capping unit is also used when the cavities 121 are filled with droplets, and the capping unit restores the ejection head 20 when it has failed to eject. In FIGS. 2 and 3, only one row of a plurality of arrayed nozzle openings 111 is shown for the sake of simplicity in the description, but the nozzle openings 111 may also be configured to be arrayed across a plurality of rows.

[Basic Waveform of Drive Signal]

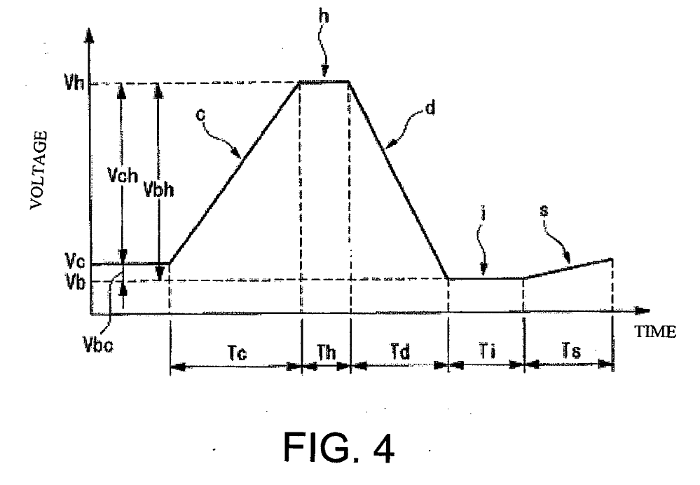

Next, the basic waveform of the drive signal that is controlled by the control device 26 and that is used to operate the piezoelectric element 150 will be described with reference to FIG. 4. FIG. 4 is a diagram showing an example of a basic waveform of the drive signal, and this waveform is a waveform for ejecting droplets from the nozzle openings 111 one at a time.

The waveform shown in FIG. 4 has a draw-in part c (first waveform part, drawing) that increases the capacity of the cavities 121 shown in FIGS. 2 and 3 to create negative pressure in the cavities 121, a hold part h (second waveform part, holding a hold potential) that holds the increased capacity of the cavities 121 for a certain period of time, a draw-out part d (third waveform part, ejecting) that abruptly reduces the capacity of the cavities 121 to increase the pressure in the cavities 121, a hold part i (fourth waveform part, holding a specific potential) that holds the reduced capacity of the cavities 121 for a certain period of time, and a vibration damping part s (increasing) that returns the reduced capacity of the cavities 121 to the original capacity and stabilizes the meniscus of the liquid in the nozzle openings. In the description below, when the time period of each part of the waveform is indicated, the letter “T” is shown together with the letter denoting the waveform portion. For example, the time period of the draw-out part d is expressed as “Td.”

The draw-in part c is a part that increases the voltage of the drive signal over a time Tc (for example, 7 μsec) in a substantially linear manner by an electric potential difference (second voltage) Vch (for example, 23 V), which is the difference between an intermediate potential (reference potential) Vc and a maximum potential (hold potential) Vh; and the hold part h is a part for holding the maximum potential Vh for a specific amount of time Th (for example, 1.4 μsec). Also, the draw-out part d is a part that lowers the voltage of the drive signal over a time Td (for example, 4.5 μsec) in a substantially linear manner at a constant slope by an electric potential difference (third voltage) Vbh (for example, 25 V), which is the difference between the maximum potential Vh and the minimum potential (specific potential) Vb; and the hold part i is a part for holding the minimum potential Vb for a specific amount of time Ti (for example, 3 μsec). The vibration damping part s is a part that increases the voltage of the drive signal over a time Ts (for example, 3 μsec) in a linear manner by an electric potential difference (first voltage) Vbc (for example, 2 V), which is the difference between the minimum potential Vb and the intermediate potential Vc.

In the present embodiment, the electric potential difference Vbc between the intermediate potential Vc and the minimum potential Vb is set to about 10% or less, preferably 4% or less, of the electric potential difference Vbh between the maximum potential Vh and the minimum potential Vb.

The time Th of the hold part h is set to ½ or less of the time Tc of the draw-in part c, and ½ or less of the time Td of the draw-out part d. More preferably, the time Th of the hold part h is set to ⅓ or less of the time Tc of the draw-in part c, and ⅓ or less of the time Td of the draw-out part d.

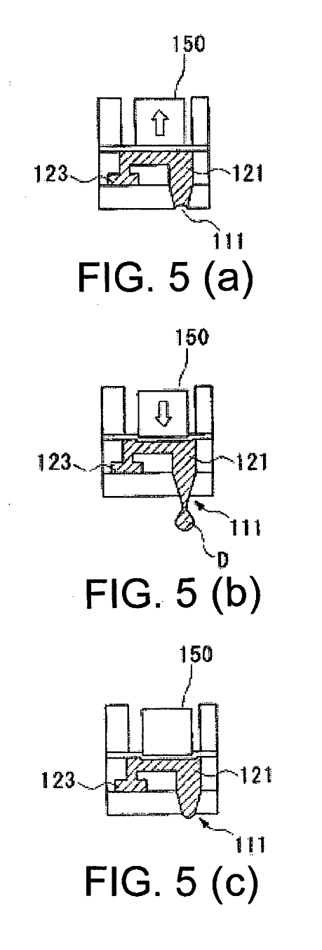

When the drive signal (waveform) described above is applied to the piezoelectric element 150, the piezoelectric element 150 ejects droplets one at a time by performing the operation shown in FIG. 5. FIG. 5 is a diagram showing the operation of droplet ejection of the piezoelectric element 150. First, when, for example, the draw-in part c in which the voltage value of the drive signal increases is applied to the piezoelectric element 150, the piezoelectric element 150 bends so as to expand the capacity of the cavities 121, creating negative pressure in the cavities 121, as shown in FIG. 5(a). The liquid is thereby supplied to the cavities 121 from the reservoir 123. Also, some of the liquid in the nozzle openings 111 is drawn into the cavities 121 as shown in the diagrams, whereby the meniscus is drawn into the nozzle openings 111.

With the drive signal described above, the electric potential difference Vch between the intermediate potential Vc and the maximum potential Vh applied by the draw-in part c is relatively large because the electric potential difference Vbc is set to 10% or less, preferably 4% or less, of the electric potential difference Vbh between the maximum potential Vh and the minimum potential Vb. Therefore, the liquid drawn into the cavities 121 has a high shearing rate. As a result, liquid with low viscosity is retained in the cavities 121.

Next, when the hold part h that follows the draw-in part c is applied to the piezoelectric element 150, the capacity of the cavities 121 is held in an expanded state while the hold part h is supplied. When the draw-out part d is subsequently applied to the piezoelectric element 150, the piezoelectric element 150 suddenly bends so as to contract the capacity of the cavities 121, creating positive pressure in the cavities 121. Droplets D are thereby ejected from the nozzle openings 111, as shown in FIG. 5(b).

At this time, the hold time Th is set to ½ or less, and preferably ⅓ or less, of the draw-in time Tc and the draw-out time Td, whereby the droplets D can be ejected from the nozzle openings 111 before the aforementioned shearing rate decreases and the viscosity increases during the holding of the liquid.

When the hold part i that follows the draw-out part d is applied to the piezoelectric element 150, the cavities 121 are held in a contracted state while the hold part h is supplied, and the meniscus in the nozzle openings 111 takes on a slightly convex shape as shown in FIG. 5(c). When the vibration damping part s is applied to the piezoelectric element 150 in this state, the piezoelectric element 150 bends so as to expand the capacity of the cavities 121 and creates negative pressure in the cavities 121. Some of the liquid in the proximity of the nozzle openings 111 is thereby drawn into the cavities 121, and the meniscus is held in a constant state.

As described above, in cases in which highly viscoelastic material is used, conventionally, the shearing rate of the liquid drawn into the cavity is not sufficiently high when the electric potential difference Vbc is greater than 10% of the electric potential difference Vbh. Accordingly, highly viscous liquid cannot be ejected, with the result that the tail parts of the ejected droplets are not easily sheared and stable ejection is difficult to achieve. However, in the present embodiment, the liquid is provided with a higher shearing rate and a lower viscosity by bringing the electric potential difference Vbc to 10% or less, preferably 4% or less, than the electric potential difference Vbh. It is therefore possible to eject droplets in a stable manner without airborne curving or other such occurrences, and it is possible to ensure a deposition diameter and precision in the deposited positions. Another feature of the present embodiment is that since the viscosity of the liquid decreases during ejection, ejection in high frequency areas (for example, a maximum of 5 kHz in the prior art, and about 10 kHz in the present embodiment) is made possible, which contributes to improved productivity.

Also, when the hold time Th is greater than ½ of the draw-in time Tc or the draw-out time Td, the shearing rate decreases and viscosity increases, and stable droplet ejection therefore becomes difficult. In the present embodiment, however, the hold time Th is set to ½ or less, and preferably ⅓ or less, of the draw-in time Tc and the draw-out time Td, whereby droplets D can be ejected from the nozzle openings 111 before the shearing rate decreases and viscosity increases during the holding of the liquid. It is therefore possible to achieve more stable droplet ejection.

A macromolecular polymer is a possible example of a highly viscoelastic liquid that is ejected using the droplet ejection method and the droplet ejecting apparatus described above. A particularly suitable macromolecular polymer is one having an average molecular weight of 70,000 or greater.

Examples of liquids include liquids in which a polyamic acid-based macromolecular polymer (average molecular weight: 70,000 to 190,000) commonly used to form an orientation film in a liquid crystal display device is dissolved in γ-butyrolactone alone or in a solvent mixture containing another solvent; PVDF solutions (2% solutions obtained by dissolving PVDF (polyvinylidene fluoride; average molecular weight: 100,000 to 150,000) in NMP (N-methyl-2-pyrrolidone)) commonly used to form binders for Li ion batteries; and liquids commonly used to form an organic EL layer in an organic EL element, which is described later.

[Method for Manufacturing the Device]

Next, the method for manufacturing the device according to an embodiment of the present invention will be described. In the following description, a method for manufacturing an organic EL substrate by using the droplet ejecting apparatus IJ is described as an example.

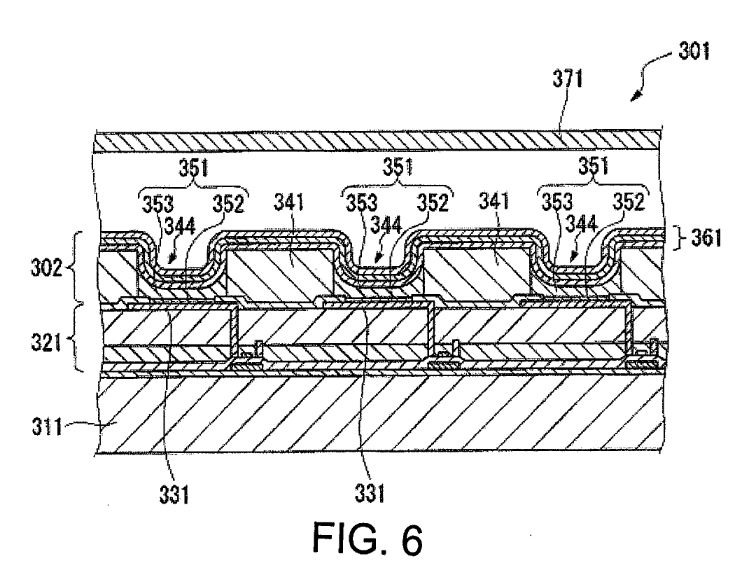

FIG. 6 is a cross-sectional view showing an example of a configuration of an organic EL device. In the organic EL device 301, the wiring and the drive IC (not shown) of a flexible substrate (not shown) are connected to an organic EL element 302 configured from a substrate 311, a circuit element unit 321, pixel electrodes 331, bank units 341, light-emitting elements 351, a cathode 361 (opposing substrate), and a sealing substrate 371, as shown in FIG. 6. The circuit element unit 321 is formed on the substrate 311, and a plurality of pixel electrodes 331 are arrayed on the circuit element unit 321. The bank units 341 are then formed in a lattice pattern between the pixel electrodes 331, and the light-emitting elements 351 are formed in concave openings 344 produced by the bank units 341. The cathode 361 is formed over the entire top of the bank units 341 and the light-emitting elements 351, and the sealing substrate 371 is layered on the cathode 361.

The process of manufacturing the organic EL device 301 that contains an organic EL element includes a bank unit formation step for forming the bank units 341, a plasma treatment step for appropriately forming the light-emitting elements 351, a light-emitting element formation step for forming the light-emitting elements 351, a counter electrode formation step for forming the cathode 361, and a sealing step for layering and sealing the sealing substrate 371 on the cathode 361.

In the plasma treatment step, the substrate P is subjected to a residue treatment to remove the resist (organic matter) residue that remains between the bank units 341 during bank formation.

Possible examples of the residue treatment include ultraviolet (UV) irradiation treatment in which the residue is treated by irradiation with ultraviolet rays, and O₂ plasma treatment in which oxygen is used as the treatment gas under atmospheric conditions. O₂ plasma treatment is used in this case. Such treatment can enhance the lyophilicity of the pixel electrodes 331.

The light-emitting element formation step involves forming the light-emitting elements 351 by forming hole injection/transport layers (thin films) 352 and light-emitting layers (thin films) 353 on the concave openings 344, and on the pixel electrodes 331 in particular. This step includes a hole injection/transport layer formation step and a light-emitting layer formation step. The hole injection/transport layer formation step includes a first droplet ejection step for ejecting liquid for forming the hole injection/transport layers 352 onto the pixel electrodes 331, and a first drying step for drying the ejected liquid to form the hole injection/transport layers 352.

In this first droplet ejection step, lyophilicity is provided to the pixel electrodes 331, and the ejected liquid can therefore smoothly wet the spaces between the bank units 341 and to form the desired pattern.

The light-emitting layer formation step includes a second droplet ejection step for ejecting liquid for forming the light-emitting layers 353 onto the hole injection/transport layers 352, and a second drying step for drying the ejected liquid to form the light-emitting layers 353. In the light-emitting element formation step, the light-emitting elements are formed using the droplet ejecting apparatus IJ described above.

The bank unit formation step as a pretreatment for the thin film formation step, which is a step for forming a light-emitting element, is preferably formed into a single series of steps having an inline connection, together with the plasma treatment step, the step for forming a thin film by droplet ejection, and the drying step based on reduced pressure, oven heating, or the like.

Possible examples of the material for forming a hole injection/transport layer include polyaniline, polythiophene, polyvinyl carbazole, mixtures of poly(3,4-ethylene dioxythiophene) and polystyrene sulfonate (PEDOT/PSS; polyethylene dioxythiophene/polystyrene sulfonate (Baytron P, Bayer Ltd. trademark)), and other high-polymer compounds.

Examples of materials suitable for forming a light-emitting layer include (poly)fluorene derivatives (PF), (poly)paraphenylene vinylene derivatives (PPV), polyphenylene derivatives (PP), polyparaphenylene derivatives (PPP), polyvinyl carbazole (PVK), polythiophene derivatives, polymethyl phenylsilane (PMPS), and other polysilanes. These high-polymer materials can also be doped with perylene-based dyes, coumarin-based dyes, rhodamine-based dyes, and other high polymer-based materials; and rubrene, perylene, 9, 10-diphenyl anthracene, tetraphenyl butadiene, Nile lead, coumarin 6, quinacridone, and other low-polymer materials. Among such organic compounds, those that that emit red light include high-polymer compounds that have an alkyl or alkoxy substituent on the benzene ring of a polyvinylene styrene derivative, and high-polymer compounds having a cyano group on the vinylene group of a polyvinylene styrene derivative. Examples of organic compounds that emit green light include polyvinylene styrene derivatives and other compounds in which an alkyl, alkoxy, or allyl derivative substituent has been introduced into a benzene ring. Examples of organic compounds that emit blue light include polyfluorene derivatives such as copolymers of dialkyl fluorine and anthracene.

In the organic EL device 301 of the present embodiment, the hole injection/transport layers 352 and the light-emitting layers 353 are formed by stable droplet ejection using the droplet ejection method described above. It is therefore possible to manufacture a high-quality device in which airborne curving does not occur and the droplets can be deposited with the desired diameter at the precise positions.

Next, a liquid crystal display device will be described.

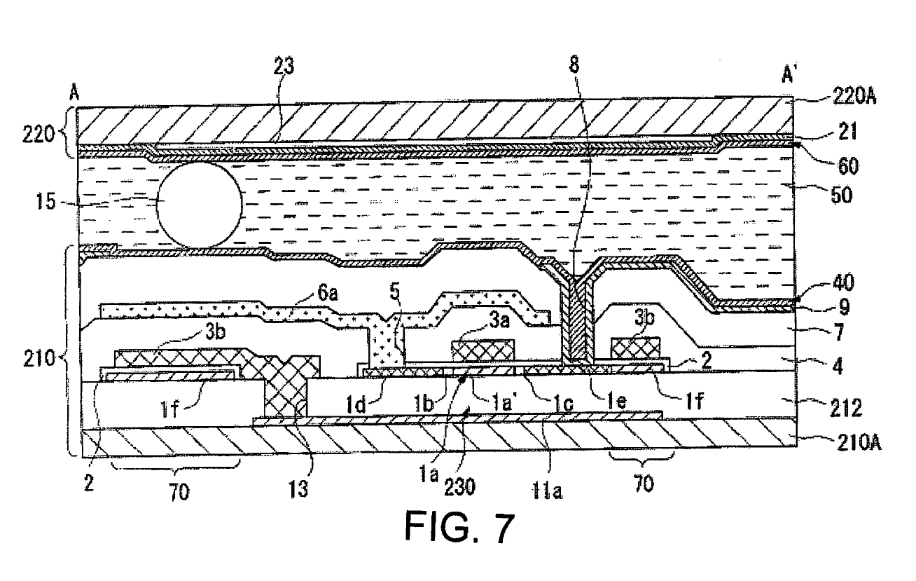

FIG. 7 is a cross-sectional view showing the configuration of the area on which a TFT element 230 is formed in the liquid crystal display device. In the liquid crystal display device of the present embodiment, a liquid crystal layer 50 is sandwiched between a TFT array substrate 210 and an opposing substrate 220 that is disposed facing this TFT array substrate.

The liquid crystal layer 50 is composed of liquid crystal in which one or more types of nematic liquid crystal are mixed together, and this layer has a specific orientation between a pair of orienting films 40 and 60. The TFT array substrate 210 primarily comprises a substrate main body 210A composed of quartz or another translucent material, as well as the TFT element 230, a pixel electrode 9, and the orienting film 40, which are formed on the surface facing the liquid crystal layer 50 of the substrate main body. The opposing substrate 220 primarily comprises a substrate main body 220A composed of glass, quartz, or another translucent material, as well as a common electrode 21 and the orienting film 60, which are formed on the surface facing the liquid crystal layer 50. The substrates 210 and 220 are kept at a specific distance from each other by a spacer 15.

In the TFT array substrate 210, the pixel electrode 9 is formed on the surface facing the liquid crystal layer 50 of the substrate main body 210A, and the pixel switching TFT element 230 for controlling the switching of all the pixel electrodes 9 is provided at a position adjacent to the pixel electrodes 9. The pixel switching TFT element 230 has an LDD (lightly doped drain) structure. The element comprises a scanning wire 3a, the channel area 1a′ of a semiconductor layer 1a in which a channel is formed by the electrical field from the scanning wire 3a, a gate insulting film 2 for insulating the scanning wire 3a and the semiconductor layer 1a, a data wire 6a, the low-concentration source area 1b and low-concentration drain area 1c of the semiconductor layer 1a, and the high-concentration source area 1d and high-concentration drain area 1e of the semiconductor layer 1a.

A second interlayer insulating film 4, in which a contact hole 5 passing all the way through to the high-concentration source area 1d and a contact hole 8 passing through to the high-concentration drain area 1e are formed, is formed on the substrate main body 210A, including the top of the scanning wire 3a and the top of the gate insulting film 2. In other words, the data wire 6a is electrically connected to the high-concentration source area 1d via the contact hole 5 that runs through the second interlayer insulating film 4.

Furthermore, a third interlayer insulating film 7, in which a contact hole 8 passing all the way through to the high-concentration drain area 1e is formed, is formed on the data wire 6a and on the second interlayer insulating film 4. Specifically, the high-concentration drain area 1e is electrically connected to the pixel electrode 9 via the contact hole 8 that runs through the second interlayer insulating film 4 and the third interlayer insulating film 7.

Also, in surface that faces the liquid crystal layer 50 of the substrate main body 210A in the TFT array substrate 210, a first light-blocking film 11a is formed in the area on which all the pixel switching TFT elements 230 are formed. Return light that is transmitted by the TFT array substrate 210, reflected by the underside (not shown) of the TFT array substrate 210 (interface between the TFT array substrate 210 and the outside air), and returned to the liquid crystal layer 50 side is prevented by the light-blocking film from reaching at least the channel area 1a′ of the semiconductor layer 1a and the low-concentration source and drain areas 1b and 1c.

Also, a first interlayer insulating film 212 for electrically insulating the semiconductor layer 1a constituting the pixel switching TFT element 230 from the first light-blocking film 11a is formed between the first light-blocking film 11a and the pixel switching TFT element 230. In addition to being formed on the TFT array substrate 210, the first light-blocking film 11a is also electrically connected to the preceding or subsequent capacitance wire 3b via a contact hole 13.

Furthermore, the orienting film 40 for controlling the orientation of the liquid crystal molecules in the liquid crystal layer 50 when no voltage is applied is formed on the outermost surface that faces the liquid crystal layer 50 of the TFT array substrate 210, specifically, on the pixel electrode 9 and the third interlayer insulating film 7. Therefore, the area provided with the TFT element 230 is configured so that a plurality of irregularities or steps are formed on the outermost surface that faces the liquid crystal layer 50 of the TFT array substrate 210, specifically, on the surface in contact with the liquid crystal layer 50.

The opposing substrate 220 is provided with a second light-blocking film 23 for preventing incident light from penetrating into the channel area 1a′ of the semiconductor layer 1a, the low-concentration source area 1b, and the low-concentration drain area 1c of the pixel switching TFT element 230. The light-blocking film is formed in the area that faces the area provided with the data wire 6a, the scanning wire 3a, and the pixel switching TFT element 230. This area lies outside the area where the openings for the pixel elements are formed, and is located on the surface that faces the liquid crystal layer 50 of the substrate main body 220A. Furthermore, the common electrode 21, which is composed of ITO or the like, is formed across substantially the entire surface that faces the liquid crystal layer 50 of the substrate main body 220A provided with the second light-blocking film 23, and the orienting film 60 for controlling the orientation of the liquid crystal molecules in the liquid crystal layer 50 when no voltage is applied is formed on the liquid crystal layer 50 side.

In the production of the liquid crystal display device, the following elements are first formed in order to configure the pixel switching TFT element 230 and other elements on the underlying substrate main body 210A composed of glass or the like: the light-blocking film 11a, the first interlayer insulating film 212, the semiconductor layer 1a, the channel area 1a′, the low-concentration source area 1b, the low-concentration drain area 1c, the high-concentration source area 1d, the high-concentration drain area 1e, a storage capacitor electrode 1f, the scanning wire 3a, the capacitance wire 3b, the second interlayer insulating film 4, the data wire 6a, the third interlayer insulating film 7, the contact hole 8, and the pixel electrode 9. Next, the substrate main body 210A is coated with an orienting film solution (for example, a high polymer that is based on the aforementioned polyamic acid and is dissolved in a solvent mixture containing γ-butyrolactone) by using the droplet ejecting apparatus IJ described above to form the orienting film 40. The orienting film 40 is subsequently rubbed in a specific direction, and the TFT array substrate 210 is produced. Also, the light-blocking film 23, the common electrode 21, and the orienting film 60 are formed on the upper substrate main body 220A, and the orienting film 60 is rubbed in a specific direction to create the opposing substrate 220. The orienting film 60 is also formed using the droplet ejecting apparatus IJ described above.

Next, a frame-shaped sealing member is formed either on the opposing substrate 220 or on the TFT array substrate 210. A specific amount of liquid crystal commensurate with the cell thickness of the liquid crystal device is fed dropwise onto the TFT array substrate 210 provided with the sealing member. Then, the TFT array substrate 210 and the opposing substrate 220 on which the droplets of liquid crystal have been applied are affixed to each other so that the liquid crystal is sandwiched therebetween, and a phase-difference plate, polarizing plate, or other optical film (not shown) is attached to the outer side of the TFT array substrate 210 and the opposing substrate 220, completing the manufacture of the liquid crystal device. This display device has the cell structure shown in FIG. 7.

In the liquid crystal display device of the present embodiment, it is possible to form orienting films 40 and 60 having excellent flatness. A liquid crystal display device having excellent display quality can be obtained because the orienting films 40 and 60 are formed in a manner in which the droplets are deposited to the desired diameter and with the desired positional precision by ejecting and drying droplets of a solution that contains a material for forming orienting films. The droplet ejecting apparatus IJ described above is used in the process.

The liquid crystal display device and the organic EL device described above are provided to notebook computers, portable phones, and other electronic devices. These electronic devices are not limited to notebook computers or portable phones, and include various other electronic devices. For example, the present invention can be applied to electronic devices such as liquid crystal projectors, multimedia personal computers (PC), engineering workstations (EWS), pagers, word processors, televisions, video tape recorders having viewfinders, direct-view video tape recorders having monitors, electronic notebooks, electronic desktop calculators, car navigation systems, POS terminals, and touch panels.

The preferred embodiments of to the present invention were described above with reference to the accompanying diagrams, but it is apparent that the present invention is not limited to these examples. The shapes and combinations of the structural components shown in these examples only are shown only as illustrations, and various modifications can be made on the basis of design requirements within a range that does not deviate from the scope of the present invention.

The terms “in front of,” “behind,” “above,” “below,” “perpendicular,” “horizontal,” “slanted,” and other terms used above for indicating directions refer to directions in the drawings used in the description. Therefore, these terms for indicating directions used for description of the present invention should be interpreted in corresponding fashion alongside the drawings used.

The terms “substantially,” “approximately,” “generally,” and other terms for indicating extents in the above description indicate appropriate amounts of deviation that are of such magnitude as they do not ultimately bring about significant changes in the present invention. These terms for indicating extents should be interpreted as including at least about ±5% error, insofar as no significant change is brought about by this deviation.

This application claims priority to Japanese Patent Application No. 2005-124595. The entire disclosure of Japanese Patent Application No. 2005-124595 is hereby incorporated herein by reference.

Only some working examples of the present invention are described above, but it is clear that one skilled in the art may add various modifications to the above working examples according to the above disclosure without exceeding the range of the present invention as defined in the claims. Furthermore, the examples described above are intended only to describe the present invention, and do not limit the range of the present invention as defined by the claims hereinafter or by equivalent claims.

[Key]

c: draw-in part (first waveform part), h: hold part (second waveform part), d: draw-out part (third waveform part), D: droplets, IJ: droplet ejecting apparatus, P, 311: substrate, Vb: minimum potential (specific potential), Vc: intermediate potential (reference potential), Vh: maximum potential (hold potential), Vbc: electric potential difference (first voltage), Vbh: electric potential difference (third voltage), Vch: electric potential difference (second voltage), 20: ejection head (head, droplet ejection head), 26: control device (signal control device), 121: cavities, 150: piezoelectric element (pressure-generating element), 301: organic EL device (device), 352: hole injection/transport layers (thin films), 353: light-emitting layers (thin films)

What is claimed is:

1. A droplet ejection method comprising:
preparing a droplet ejecting apparatus having a casing including a cavity storing liquid internally and a nozzle opening facing outwardly from said cavity, said droplet ejecting apparatus having a pressure generating element being configured on said casing to change volume of said cavity;
drawing said liquid to supply to said cavity by creating negative pressure in said cavity by increasing a potential of a drive signal being applied to said pressure generating element by a second voltage from a reference potential to a hold potential, said reference potential being higher than a specific potential by a first voltage;
holding said hold potential;
ejecting said liquid from said nozzle opening by causing positive pressure in said cavity by decreasing a potential by a third voltage from said hold potential to said specific potential, said third voltage being 10 times or more than said first voltage.

2. The droplet ejecting method according to claim 1, wherein
said third voltage is 25 times or more than said first voltage.

3. The droplet ejecting method according to claim 1, further comprising
holding said specific potential.

4. The droplet ejecting method according to claim 3, further comprising
increasing a potential by said first voltage from said specific potential to said reference potential.

5. The droplet ejection method according to claim 1, wherein
a time period of holding said hold potential is ½ or less the time period of drawing said liquid and ½ or less of the time period of ejecting said liquid from said nozzle.

6. The droplet ejection method according to claim 5, wherein
the time period of holding said hold potential is ⅓ or less the time period of drawing said liquid and ⅓ or less the time period of ejecting said liquid.

7. The droplet ejection method according to claim 6, wherein
said second voltage is 23V, and
drawing said liquid is 7μ second.

8. The droplet ejection method according to claim 7, wherein
holding said hold potential is 1.4μ second.

9. The droplet ejection method according to 1, wherein
said liquid contains a macromolecular polymer with an average molecular weight of 70,000 or more.

10. The droplet ejection method according to claim 1, wherein
said liquid is selected from a group consisting of ink containing colored material, dispersion liquid containing metal microparticles or other materials, a light emitting material, an organic EL material, a liquid crystal material, a highly viscous functional liquid; a functional liquid containing a micro-lens material, and a biopolymer solution containing proteins or nucleic acids.

11. The droplet ejection method according to claim 1, wherein
said ejecting said liquid includes ejecting said liquid into a substrate of an electric device.

12. The droplet ejection method according to claim 11, further comprising
lyophilizing said substrate before ejecting said liquid.

13. A liquid ejecting apparatus, comprising:
a casing having a cavity storing liquid internally and a nozzle opening facing outwardly from said cavity;
a pressure generating element being configured on said casing to change volume of said cavity and
a control device controlling supply of said liquid to said cavity by creating negative pressure in said cavity by increasing a potential of a drive signal being applied to said pressure generating element by a second voltage from a reference potential to a hold potential, said reference potential being higher than a specific potential by a first voltage, said control device controlling holding of said hold potential, said control device controlling ejecting said liquid from said nozzle opening by causing positive pressure in said cavity by decreasing a potential by third voltage from said hold potential to said specific potential, said third voltage being 10 times or more than said first voltage.

14. The droplet ejecting method according to claim 13, wherein
said third voltage is 25 times or more than said first voltage.

15. The droplet ejection apparatus according to claim 13, wherein
a casing includes a reservoir as a flow duct to supply said liquid.

16. The droplet ejection apparatus according to claim 15, wherein
said pressure generating element is a ferroelectric crystal having a perovskite structure.

17. The droplet ejection apparatus according to claim 16, further comprising
a reserve tank for said liquid, and
a flow channel configured between said casing and said tank to supply said liquid to said reservoir.

18. The droplet ejection apparatus according to claim 13, wherein
said control device controls holding said specific potential for a prescribed time.

19. The droplet ejection apparatus according to claim 18, wherein
said control device controls increasing a potential by said first voltage from said specific potential to said reference potential.

20. The droplet ejection apparatus according to claim 13, wherein
the time period of holding said hold potential is ½ or less of the time period of supplying said liquid to said cavity and ½ or less of the time period of ejecting said liquid.

21. The droplet ejection apparatus according to claim 20, wherein
the time period of holding hold potential is ⅓ or less of the time period of supplying said liquid to said cavity and ⅓ or less of the time period of ejecting said liquid.

22. The droplet ejection apparatus according to 13, wherein
said liquid contains a macromolecular polymer with an average molecular weight of 70,000 or more.

23. The droplet ejection apparatus according to 13, wherein
said liquid is selected from a group consisting of ink containing colored material, dispersion liquid containing metal microparticles or other materials, a light emitting material, an organic EL material, a liquid crystal material, a highly viscous functional liquid; a functional liquid containing a micro-lens material, and a biopolymer solution containing proteins or nucleic acids.
